(19) United States
(12) Patent Application Publication
(10) Pub. No.: US 2008/0055096 A1
(43) Pub. Date: Mar. 6, 2008

(54) Real-time modeling analysis of hazards data with large numbers of locations and with customized reporting and web-based delivery

(76) Inventor: James A. Aylward, Belmont, MA (US)

Correspondence Address: Mark J. Pandiscio;Pandiscio & Pandiscio, P.C., 470 Totten Pond Road, Waltham, MA, 02451-1914, US

(21) Appl. No.: 11/811,250

(22) Filed: Jun. 8, 2007

Related U.S. Application Data
(60) Provisional application No. 60/812,331, filed on Jun. 9, 2006.

(51) Int. Cl. G01W 1/00

(52) U.S. Cl. 340/601

(57) ABSTRACT

A system for monitoring hazards and determining potential loss exposure resulting from those hazards, the system comprising:
a first user input component for permitting a user to specify at least one geographic location to be monitored;
a second user input component for permitting a user to specify at least one hazard parameter to be monitored for the at least one monitored location;
a first data acquisition component for acquiring hazard data for the at least one monitored location, wherein the first data acquisition component is configured to acquire the data from at least two disparate data sources and aggregate that data in a seamless data set;
a second data acquisition component for acquiring data regarding entities associated with the at least one monitored location;
an analytical engine for determining the potential loss exposure to the entities associated with the at least one monitored location resulting from the occurrence of hazards at the at least one monitored location; and
a reporting engine for reporting the results of the analytical engine to a user.

A method for monitoring hazards and determining potential loss exposure resulting from those hazards, the method comprising:
specifying (i) at least one geographic location to be monitored, and (ii) at least one hazard parameter to be monitored for the at least one monitored location, and acquiring (a) hazard data for the at least one monitored location, wherein the acquired hazard data is from at least two disparate data sources, and aggregating the hazard data into a seamless data set, and (b) acquiring data regarding insured entities associated with the at least one monitored location;
determining potential loss exposure to the entities associated with the at least one monitored location resulting from the occurrence of hazards at the at least one monitored location; and
reporting the determined potential loss exposure to a user.

### REFERENCE TO PENDING PRIOR PATENT APPLICATION

This patent application claims benefit of pending prior U.S. Provisional Patent Application Ser. No. 60/812,331, filed Jun. 9, 2006 by James A. Aylward for REAL TIME MODELING ANALYSIS OF HAZARDS DATA WITH LARGE NUMBERS OF LOCATIONS (INSMAP) WITH WEB BASED DELIVERY AND CUSTOMIZED REPORTING (Attorney's Docket No. HDM-12 PROV), which patent application is hereby incorporated herein by reference.

### FIELD OF THE INVENTION

The present invention relates to data collection, analysis and reporting in general, and more particularly to hazard data collection, analysis and reporting.

### BACKGROUND OF THE INVENTION

There are currently many hazards that affect human life and property, including weather (e.g., floods, hail, intense winds, etc.), earthquakes, wild fires, terrorism, etc. Data relating to such hazards (“hazards data”) are currently available through a variety of government agencies (e.g., the National Oceanic & Atmospheric Administration (NOAA), the Federal Emergency Management Agency (FEMA), etc.) as well as a variety of commercial sources (e.g., aviation weather services, nautical weather services, etc.).

However, each of these data sources tends to be relatively specialized, providing data for specific purposes and hence, generally providing data for only one or two natural phenomena. Thus, a data source providing information regarding weather will not tend to provide information regarding earthquakes, and a data source providing information regarding wild fires will not tend to provide information regarding flooding, etc.

Furthermore, inasmuch as most queries for hazard information tend to arise with respect to specific geographically-based needs, the data sources tend to report their data for a relatively localized region. By way of example but not limitation, where a pilot is flying from Detroit to Cleveland, the pilot will typically query a database for weather conditions in the Detroit, Cleveland and intervening areas, without concern for weather conditions in Houston.

As a result, there is currently a large quantity of hazards data available, but it tends to be relatively segregated according to the specific applications for which it is assembled. There is currently no easy way to aggregate this hazards data and then mine it for purposes which are separate from those for which the individual databases were created. In other words, while numerous hazard data sets are currently available, there is no simple way to aggregate these disparate hazard data sets and then utilize them, flexibly and selectively, for a wide range of particular needs.

The foregoing deficiencies with currently-available hazard data sets becomes particularly problematic when attempting to conduct modeling analysis of hazards data in order to predict property insurance exposures and, in extreme cases, life insurance exposures. In other words, insurance underwriters currently have no simple way to harness the numerous, but disparate, hazard data sets currently available and utilize them in a coordinated fashion so as to predict insurance exposures across a broad geographic region.

Thus, there is an urgent need for a new and improved system for aggregating numerous, but disparate, hazard data sets across broad geographic regions and then mining those aggregated hazard data sets, flexibly and selectively, for a wide range of specific purposes.

### SUMMARY OF THE INVENTION

This and other objects are addressed by the present invention, which comprises a novel system for aggregating numerous, but disparate, specialized hazard data sets so as to provide a broad spectrum of hazards data, and then enabling selected data to be quickly and easily harvested according to the targeted interests of specific users. In this way, the present invention provides a particularly robust tool which can be used to gain insights into the aggregated hazards data which is not possible when reviewing any single hazards data set. By way of example but not limitation, the present invention provides a system to harness the numerous, but disparate, hazard data sets currently available from a variety of different sources and overlays them in real-time on any size portfolio of individual locations worldwide. In other words, the present invention makes it possible to monitor millions, or even hundreds of millions, of properties for their exposure to hazards.

In one preferred form of the present invention, there is provided a system for monitoring hazards and determining potential loss exposure from those hazards, the system comprising:

a first user input component for permitting a user to specify at least one geographic location to be monitored;

a second user input component for permitting a user to specify at least one hazard parameter to be monitored for the at least one monitored location;

a first data acquisition component for acquiring hazard data for the at least one monitored location, wherein the first data acquisition component is configured to acquire the data from at least two disparate data sources and aggregate that data in a seamless data set;

a second data acquisition component for acquiring data regarding entities associated with the at least one monitored location;

an analytical engine for determining potential loss exposure to the entities associated with the at least one monitored location resulting from the occurrence of hazards at the at least one monitored location; and

a reporting engine for reporting the results of the analytical engine to a user.

In another preferred form of the present invention, there is provided a method for monitoring hazards and determining potential loss exposure resulting from those hazards, the method comprising:

specifying (i) at least one geographic location to be monitored, and (ii) at least one hazard parameter to be monitored for the at least one monitored location, and acquiring (a) hazard data for the at least one monitored location, wherein the acquired hazard data is from at least two disparate data sources, and aggregating the hazard data into a seamless data set, and (b) acquiring data regarding entities associated with the at least one monitored location;

determining potential loss exposure to the entities associated with the at least one monitored location resulting from the occurrence of hazards at the at least one monitored location; and

reporting the determined potential loss exposure to a user.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like elements, and further wherein:

FIG. 1 is a schematic diagram showing how the present invention collects, analyzes and reports hazards data;

FIG. 2 is a schematic diagram showing how hazards data is formatted in a standardized InsMap™ format;

FIG. 3 is a schematic diagram showing various details of the operation of the system's analytical engine;

FIG. 4 is a schematic diagram showing a preferred system architecture of the present invention; and

FIG. 5 is a schematic diagram showing how the present invention may be applied to an exemplary business application.

### DETAILED DESCRIPTION OF THE INVENTION

### In General

The present invention provides a real-time monitoring system for determining potential loss exposure to hazards. More particularly, this system can be used to monitor virtually any location (or any number of locations) for any hazard (or any group of hazards) for which hazards data are available. Furthermore, this system can be used to predict, by location (e.g., by address, by targeted geographic region, by latitude/longitude, by specific X,Y coordinates, by census blocks, by geographic boundary lines, etc.), the potential loss exposure from specific hazard events such as floods, hurricanes, tornadoes, etc. In addition, this new system can be integrated with existing database, analysis and/or visual display systems so as to provide users with dramatically-enhanced levels of information.

For the purposes of the present application, the real-time system for monitoring hazards and determining potential loss exposure from those hazards will sometimes hereinafter be referred to as the “InsMap™ system”, which refers to one application of the novel system being developed by the Harvard Design & Mapping division of First American Real Estate Solutions, LLC.

Among other things, the InsMap™ system permits the user to aggregate numerous, but disparate, hazards data sets across broad geographic regions, extract selected hazards data according to user-specific needs, and then utilize the extracted hazards data for modeling purposes so as to determine potential loss exposure resulting from hazard events. By way of example but not limitation, the InsMap™ system permits an insurance underwriter to monitor a real estate portfolio with respect to one or more specific natural hazards (e.g., flooding and high winds) so as to determine potential financial losses resulting from the occurrence of the monitored hazards.

In one preferred form of the invention, the InsMap™ system provides three major data products for the user:
1. Portfolio Monitoring Web Services;
2. Hazard Analysis Reports; and
3. Data Streams.

1. Portfolio Monitoring Web Services.

Users provide the InsMap™ system with single locations or entire portfolios of locations for periodic (e.g., daily or hourly or “as it happens”) analysis vis-a-vis all of the hazards which are being monitored by the InsMap™ system. The specific locations to be monitored may be specified in the form of addresses, geographic regions, longitude/latitude coordinates, specific X,Y coordinates, census blocks, geographic boundary lines, etc. There is no limit to the number of locations which may be monitored or to the areas which may be monitored (e.g., the system may provide worldwide coverage). Users also provide the InsMap™ system with data regarding entities associated with those locations, e.g., users provide the InsMap™ system with financial attributes, property characteristics, location-specific information and other data regarding properties and/or populations associated with those locations. The InsMap™ system then, periodically (e.g., daily or hourly or “as it happens”), automatically reports to users on the hazards affecting the monitored locations and on the potential loss exposure to the entities associated with the monitored locations (e.g., the financial loss exposure to properties and/or populations associated with the monitored locations).

2. Hazard Analysis Reports.

Users provide the InsMap™ system with single or multiple locations to be monitored, with data regarding the properties (and/or populations) associated with those locations, and identify parameters for which these locations are to be monitored, e.g., a specific date, a specifically-named hazard event (e.g., Hurricane Katrina), or some other parameter. The InsMap™ system then provides the user with a Hazard Analysis Report on the potential loss exposure to the properties and/or populations associated with the monitored locations. The Hazard Analysis Report may be provided to the user as an XML database, as a fully populated PDF report form, or in another format desired by the user.

3. Data Streams.

Users provide the InsMap™ system with single or multiple locations to be monitored, and identify parameters for which these locations are to be monitored, e.g., a specific date, a series of dates, a specifically-named hazard event (e.g., Hurricane Katrina), or some other parameter. Users then receive a data stream from the InsMap™ system which has been pre-processed to include only that hazards data which is relevant to (i) the monitored locations, and (ii) the pre-determined parameter. For example, a user might specify that they wish to receive precipitation data, but only for selected property locations and only when the precipitation meets a certain pre-determined threshold, e.g., rainfall which exceeds 3 inches in a 72 hour period. The InsMap™ system then creates a pre-processed data stream which is pushed to the user's system for integration into the user's own analysis processes.

Technical Details of Data Processing Within the InsMap™ System

As noted above, the InsMap™ system is a real-time system for monitoring hazards and determining potential losses and other exposure resulting from those hazards. Data processing within the InsMap™ system involves identifying (i) the specific locations which are to be monitored, (ii) the properties and/or populations which are associated with the monitored locations, (iii) the hazard event(s) which are to be considered for the monitored location, and then reporting estimated losses and other exposures for the monitored locations based upon the hazards criteria being considered. The functionalities of the InsMap™ system can generally be classified into four categories:
1. Data Gathering;
2. Data Processing and Geospatial Analysis;
3. Data Distribution; and
4. Hazard Reporting and Presentation.

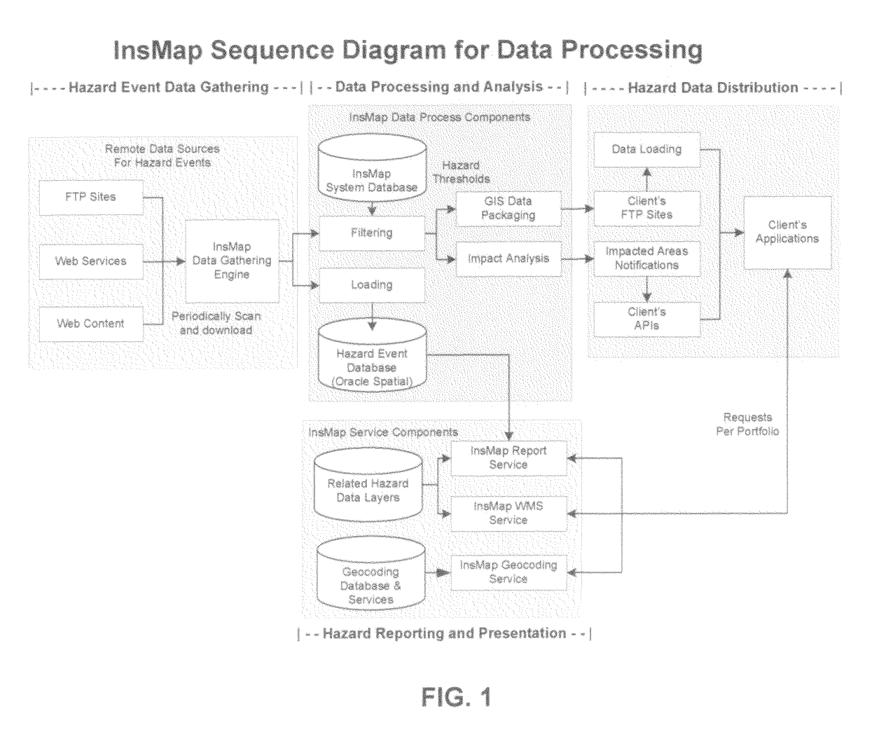

FIG. 1 illustrates how the InsMap™ system collects, analyzes and reports hazards data.

1. Data Gathering.

The InsMap™ system collects hazards data on a wide variety of different hazards from numerous, disparate data sources. By way of example but not limitation, the InsMap™ system collects hazards data relating to floods, hail, intense winds, hurricanes, tornadoes, earthquakes, wild fires, etc. from government agencies such as NOAA and FEMA and from commercial sources such as aviation weather services, nautical weather services, etc. and makes this data available for seamless harvesting according to user-specific criteria. In one preferred form of the invention, the InsMap™ system gathers hazards data through three major channels:
FTP/Secure FTP;
Remote Web Service API; and
Remote Web Content.

FTP/Secure FTP. External data providers (e.g., government agencies, commercial sources, etc.) deposit hazards data in pre-structured file directories of FTP servers. The InsMap™ system periodically scans the file directories of these FTP servers and downloads the desired hazard data sets into a server provided by the InsMap™ system.

Remote Web Service/API. The InsMap™ system periodically sends requests across the Web to remote servers to request hazard data sets from data providers. These requests are compatible with the API (Application Programming Interface) specifications of the data providers so as to facilitate automatic retrieval of the requested hazard data sets for incorporation into the InsMap™ system.

Remote Web Content. The InsMap™ system periodically extracts hazard data sets from the Web content available from remote Web sites (e.g., www.usgs.gov, www.nws.noaa.gov, etc.), and converts the acquired information into usable data formats for incorporation into the InsMap™ system.

In addition to the foregoing, the InsMap™ system also permits the user to specify those geographic locations which are to be monitored.

Furthermore, the InsMap™ system also gathers data with respect to the entities (e.g., properties and/or populations) associated with the user-specified locations which are to be monitored. Data regarding the properties and/or populations associated with the user-specified locations may be provided to the InsMap™ system by the user, or this data may be acquired from other sources (e.g., government agencies, private sources, etc.).

Again, the afore-mentioned FTP/Secure FTP, Remote Web Service API, and Remote Web Content approaches may be used when acquiring data relating to (i) the user-specified geographic locations which are to be monitored, and (ii) the properties and/or populations associated with those user-specified locations.

2. Data Processing and Geospatial Analysis.

As noted above, the InsMap™ system is provided with (i) the geographic locations which are to be monitored, (ii) data regarding the properties and/or populations associated with those locations, and (iii) hazard data sets relating to those locations. The InsMap™ system then automatically overlays the hazards datasets affecting the monitored locations and determines the potential hazards exposure to properties and/or populations associated with the monitored locations.

In one preferred form of the invention, the InsMap™ system provides this functionality through four major processes:
Data Loading;
Data Filtering;
Geospatial Impact Analysis; and
Data Packaging.

Data Loading. The InsMap™ system is loaded with (i) the geographic locations which are to be monitored, (ii) data regarding the properties and/or populations associated with those locations, and (iii) hazard data sets relating to those locations. When new hazards data reaches the InsMap™ system the InsMap™ system automatically executes database scripts to load or append the new hazards data into a hazard database maintained by the InsMap™ system. In one preferred form of the invention, the InsMap™ system has its hazards database configured using the Spatial™ software component available from the Oracle Corporation. Since this new hazards data is automatically loaded into the Oracle® Spatial™ database maintained by the InsMap™ system, the InsMap™ system is immediately capable of conducting comprehensive spatial analysis with respect to the loaded hazards data (e.g., earthquakes, severe winds, etc.) against the monitored locations.

Data Filtering. The InsMap™ system is configured to filter the hazards data by pre-defined thresholds relating to the severity of a hazard and/or the risk associated with a hazard. The pre-defined thresholds for different hazard events are stored in tables maintained by the InsMap™ system.

Geospatial Impact Analysis. The InsMap™ system is configured to analyze hazards data and determine whether a monitored location will be impacted, i.e., if, and to what extent, a hazard will affect the monitored location. Lists of the impacted locations can be sent to a user's application program (e.g., an application of the sort available from Veros Software Inc.).

The InsMap™ system is also configured to analyze hazards data vis-à-vis the monitored locations, and the entities (properties and/or populations) associated with those monitored locations, and determine potential losses and other exposure resulting from occurrences of hazards at the monitored locations. The results of this analysis can then be sent to users as reports.

Data Packaging. The InsMap™ system allows a user to specify a desired format for data being sent to the user. The InsMap™ system is configured to automatically convert, as necessary, any data being sent to the user in order to comply with the user's specified data format.

3. Data Distribution.

The InsMap™ system is configured so that data may be distributed to the users in a variety of ways. In one preferred form of the invention, the InsMap™ system is configured to distribute data to the users via the following three (independent) approaches:
Upload The Filtered Data Sets To A User's Servers;
Load The Filtered Data Sets Into A User's Remote Geospatial Database Servers (Optional);
Send A Notification Of Hazard Events To A User Or A User's Web Service.

Upload The Filtered Data Sets To A User's Servers. Based on customer-defined thresholds for hazard events, the InsMap™ system uploads the filtered hazard data sets to a user's servers through a secure FTP service. Preferably, the filtered hazard data sets are uploaded in a GIS data format (e.g., the shape file format of Environmental Systems Research Institute, Inc. (ESRI®), or the Spatial™ file format of the Oracle Corporation, etc.).

Load The Filtered Data Sets Into A User's Remote Geospatial Database Servers (Optional). The InsMap™ system also has the ability to execute database scripts to automatically load the filtered hazard data sets directly into a user's geospatial databases (e.g., an Oracle® Spatial™ database or an ESRI® SDE Geo™ database). After the hazard data sets are loaded into a user's database, the user's own application software can run various analyses and view the hazard data with the user's own portfolio.

Send A Notification Of Hazard Events To A User Or A User's Web Service. Based on user-defined thresholds for hazards data, the InsMap™ system sends a hazards alert (e.g., in the form of an XML document) to a user's E-mail service or to a user's Web service. The hazards alert identifies all monitored locations for which a monitored hazard event exceeds the pre-defined thresholds. Users may then use this information to identify impacted entities (e.g., properties and/or populations) and apply additional logic into their analyses (e.g., apply additional business logic to insurance underwriting analyses, etc.).

4. Hazard Reporting and Presentation.

As noted above, the InsMap™ system is loaded with (i) the geographic locations which are to be monitored, (ii) data regarding the properties and/or populations associated with those locations, and (iii) hazard data sets relating to those locations. The InsMap™ system then reports determined hazard exposure for the monitored locations based upon the hazards criteria being considered.

In one preferred form of the invention, the user provides the InsMap™ system with the geographic locations of a portfolio of properties or other insured entities (e.g., individuals), and with data regarding the properties and/or individuals related to those locations. The InsMap™ system then overlaps the targeted geographic locations with filtered hazards data. This may be done either periodically (e.g., daily) or on demand. By way of example but not limitation, users may submit single or multiple locations to the InsMap™ system via FTP for analysis on demand, or users may deposit an entire portfolio of properties on the InsMap™ system servers for continuous (e.g., hourly) overlay analysis.

The InsMap™ system is then configured to automatically generate reports predicting losses for the monitored locations based upon the hazards criteria being considered. The InsMap™ system then provides these reports to the user for use in user-specific applications (e.g., insurance underwriting applications). By way of example but not limitation, the InsMap™ system is configured to issue Hazard Analysis Reports which predict losses for monitored locations based upon the occurrences of hazard events which exceed a pre-determined threshold. By way of further example but not limitation, users identify single or multiple locations to be monitored to the InsMap™ system via standard HTTP protocols, and receive back fully-developed PDF reports with hazards information, including proximity to a hazard event, imagery and/or other data, or the users receive back an XML document from which the users can build their own reports.

The InsMap™ system is preferably configured to include a variety of pre-configured Hazard Analysis Reports templates. By way of example but not limitation, APPENDIX A lists a number of exemplary Hazard Analysis Reports and the data contained in each. Of course, many other types of pre-configured Hazard Analysis Reports may also be provided. Additionally, the InsMap™ system is preferably configured to permit the use of user-defined Hazard Analysis Reports.

APPENDIX B shows various exemplary screen displays which may be used to provide information to a user. Again, the InsMap™ system is preferably configured to permit the use of various other screen displays.

Among other things, if desired, the system can be configured to provide the user with news alerts pertinent to the monitored locations and/or the hazard parameters specified by the user.

### Data Consistency

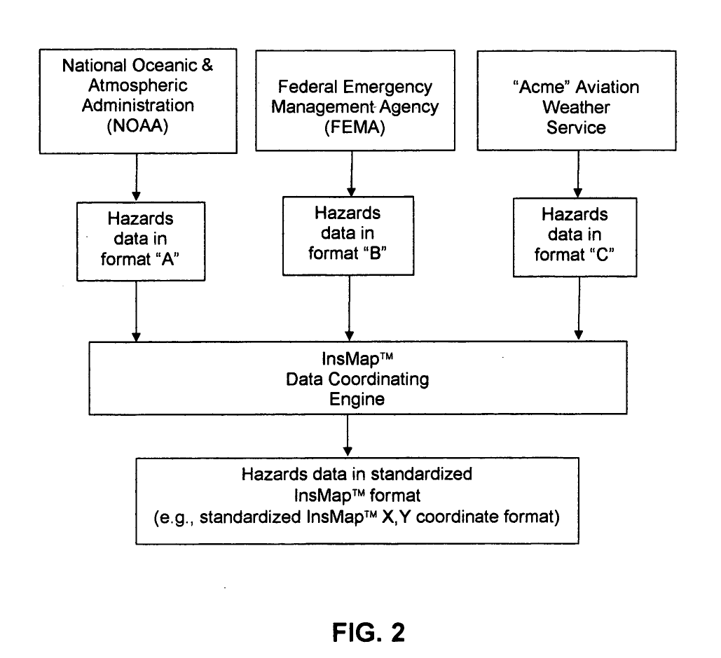

In one preferred form of the present invention, as each monitored location is entered into the system, using any desired specification approach (e.g., by address, by targeted geographic region, by latitude/longitude, by specific X,Y coordinates, by census block, etc.), that location is geocoded (i.e., provided with a standardized InsMap™ X,Y coordinate). Similarly, as property and/or population data associated with a monitored location is entered into the system, this property and/or population data is indexed according to the standardized InsMap™ X,Y coordinate system. Furthermore, as hazards data is entered into the system, this hazards data is indexed according to the standardized InsMap™ X,Y coordinate system. Thus, even though numerous kinds of data is drawn from a variety of disparate databases, the InsMap™ system is capable of collecting, analyzing and reporting information on a consistent basis. See, for example, FIG. 2.

### Analytical Engine

As noted above, the present invention preferably comprises an analytical engine for determining potential loss exposure to the entities associated with the monitored locations due to the occurrence of hazards at the monitored locations.

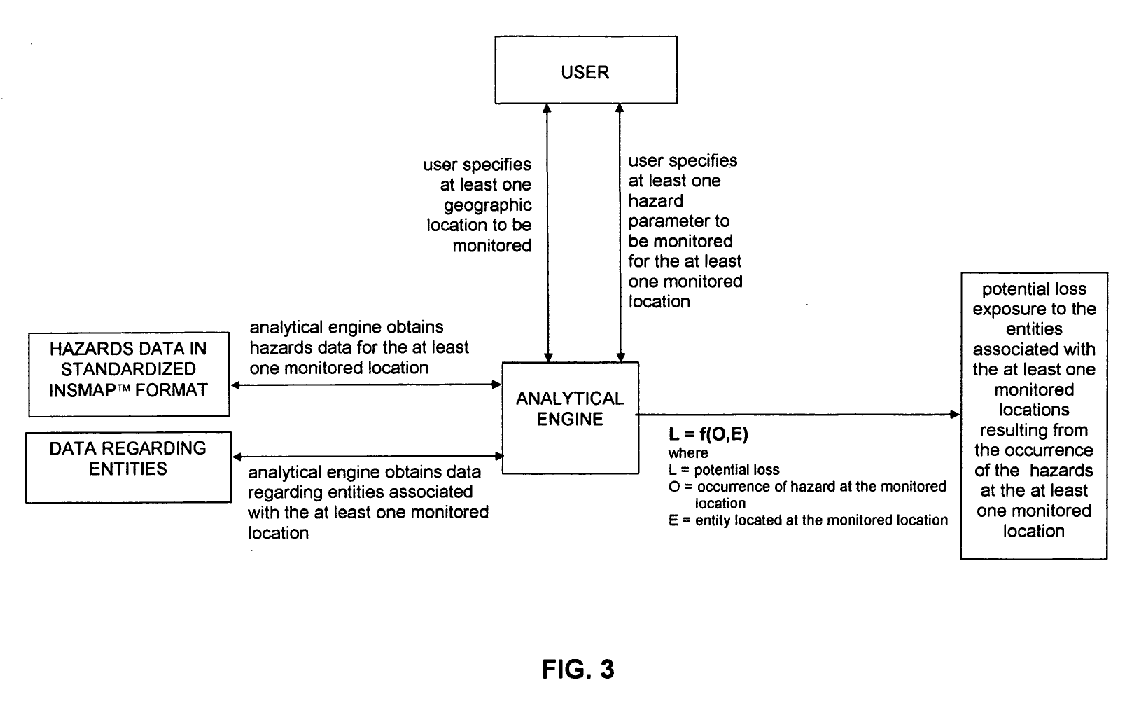

More particularly, and looking now at FIG. 3, the analytical engine (i) permits the user to specify the geographic locations to be monitored, (ii) permits the user to specify hazard parameters to be monitored for the monitored locations, (iii) obtains hazards data for the monitored locations, (iv) obtains data regarding entities associated with the monitored locations, and (v) determines potential loss exposure to the entities associated with the monitored locations due to the occurrence of the hazards at the monitored locations.

By way of example but not limitation, a user might specify the metropolitan Houston area as the geographic location to be monitored, and specify rainfall in excess of 3 inches per hour, and winds in excess of 30 miles per hour, as the hazard parameters to be monitored for the monitored location; and the analytical engine then obtains hazards data for the monitored location, obtains data regarding insured real estate associated with the monitored location, and then determines potential loss exposure to the insured real estate associated with the monitored location due to the occurrence of the specified hazards at the monitored location.

### Entities

As noted above, the analytical engine determines potential loss exposure to the entities associated with the monitored locations due to the occurrence of the hazards at the monitored locations.

In this respect, it should be appreciated that the aforementioned entities may constitute substantially any entities associated with the monitored locations. By way of example but not limitation, the aforementioned entities may comprise (i) fixed real estate or other stationary structures or equipment located at the monitored locations (e.g., a building or house, a fuel storage facility, a pipeline, a water tower, a cooling tower, electrical lines, an airport, a port facility, a real estate feature such as farmland, a mine, a lake, a canal, landscaping, etc.), (ii) movable equipment located at the monitored locations (e.g., a ship, an airplane, a barge, a train, a truck, a mobile home, mining equipment, manufacturing equipment, etc.), (iii) populations located at the monitored locations (e.g., human beings, livestock, wildlife, etc.) etc. Where the entity is mobile (e.g., a ship or a member of a population), association of the entity with a given geographic location may be established by tracking devices attached to the entity (e.g., a tracker attached to a ship or an ankle bracelet attached to an individual). Alternatively, association of the entity with a given geographic location may be established by home base (e.g., the home base of a ship) or by domicile (e.g., the domicile of an individual).

Furthermore, it should be appreciated that the entities may be of interest for a variety of reasons. By way of example but not limitation, the entity may be of interest to a government authority managing emergency situations (e.g., the Federal Emergency Management Agency when charting the path of a hurricane), an insurance company (e.g., a commercial insurer assessing underwriting risks associated with insured real estate in a flood zone), etc.

### InsMap System Architecture

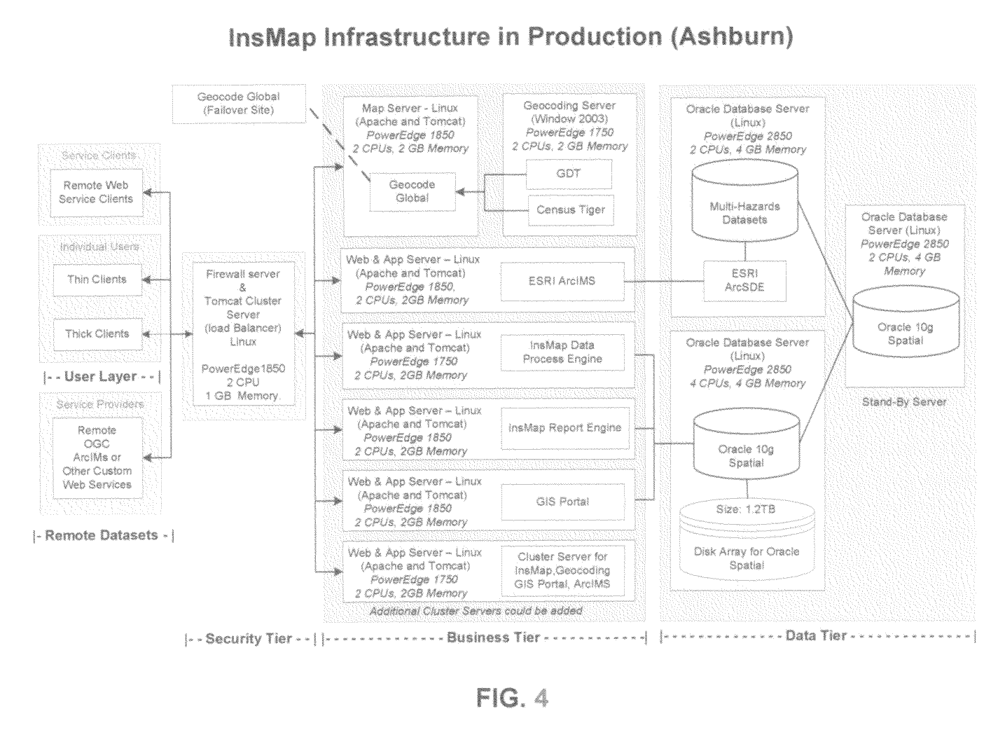

In one preferred form of the invention, the InsMap™ system uses the system architecture shown in FIG. 4.

### InsMap Integration with First American Flood Applications

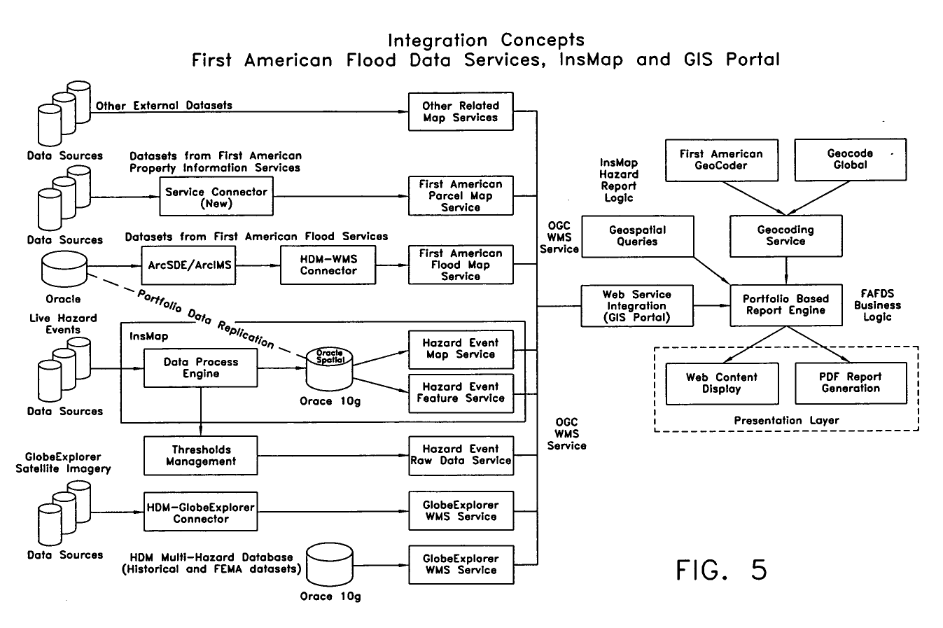

The InsMap™ system provides a foundation for collecting, analyzing and reporting hazard data sets. The InsMap™ system can be used in conjunction with other data products. By way of example but not limitation, the InsMap™ system can be used in conjunction with other data products offered by First American Real Estate Solutions, LLC. See FIG. 5, which displays a few high level concepts for integrating the InsMap™ system with other data products offered by First American Real Estate Solutions, LLC.

### Modifications

It will be understood that many changes in the details, materials, steps and arrangements of parts, which have been herein described and illustrated in order to explain the nature of the invention, may be made by those skilled in the art without departing from the principles and scope of the present invention.

What is claimed is:

1. A system for monitoring hazards and determining potential loss exposure resulting from those hazards, the system comprising:
a first user input component for permitting a user to specify at least one geographic location to be monitored;
a second user input component for permitting a user to specify at least one hazard parameter to be monitored for the at least one monitored location;
a first data acquisition component for acquiring hazard data for the at least one monitored location, wherein the first data acquisition component is configured to acquire the data from at least two disparate data sources and aggregate that data in a seamless data set;
a second data acquisition component for acquiring data regarding entities associated with the at least one monitored location;
an analytical engine for determining potential loss exposure to the entities associated with the at least one monitored location resulting from the occurrence of hazards at the at least one monitored location; and
a reporting engine for reporting the results of the analytical engine to a user.

2. A system according to claim 1 wherein the system operates in real-time.

3. A system according to claim 1 wherein the first user input component is configured to receive location information in a selected format, wherein the selected format comprises at least one from the group consisting of address, targeted geographic region, latitude/longitude, specific X,Y coordinates, census blocks and geographical boundary lines.

4. A system according to claim 1 wherein the second user input component is configured to receive the at least one hazard parameter on the basis of hazard type.

5. A system according to claim 4 wherein the hazard type comprises at least one from the group consisting of: weather, earthquakes and wild fires.

6. A system according to claim 1 wherein the second user input component is configured to receive the at least one hazard parameter on the basis of a pre-determined numeric threshold.

7. A system according to claim 1 wherein the first data acquisition component is configured to acquire natural hazardhazard data using at least one from the group consisting of: FTP, remote Web service API, and remote Web content.

8. A system according to claim 1 wherein the first data acquisition component aggregates the hazard data using a standardized coordinate system.

9. A system according to claim 8 wherein the standardized coordinate system comprises a standardized X,Y coordinate system.

10. A system according to claim 1 wherein the second data acquisition component is configured to acquire data regarding insured property.

11. A system according to claim 10 wherein the potential loss exposure comprises financial loss associated with damage to insured property.

12. A system according to claim 1 wherein the second data acquisition component is configured to acquire data regarding insured populations.

13. A system according to claim 12 wherein the potential loss exposure comprises financial loss associated with the impact of the hazard on the insured population.

14. A system according to claim 13 wherein the financial loss is associated with at least one from the group consisting of loss of life, disability and job disruption.

15. A system according to claim 1 wherein the reporting engine is configured to report the results of the analytical engine using at least one from the group consisting of: portfolio monitoring web services, hazard analysis reports and data streams.

16. A method for monitoring hazards and determining potential loss exposure resulting from those hazards, the method comprising:
specifying (i) at least one geographic location to be monitored, and (ii) at least one hazard parameter to be monitored for the at least one monitored location, and acquiring (a) hazard data for the at least one monitored location, wherein the acquired hazard data is from at least two disparate data sources, and aggregating the hazard data into a seamless data set, and (b) acquiring data regarding insured entities associated with the at least one monitored location;
determining the potential loss exposure to the entities associated with the at least one monitored location resulting from the occurrence of hazards at the at least one monitored location; and
reporting the determined potential loss exposure to a user.

17. A method according to claim 16 wherein the steps occur in real-time.

18. A method according to claim 17 wherein location information is specified in a selected format, wherein the selected format comprises at least one from the group consisting of address, targeted geographic region, latitude/longitude, specific X,Y coordinates, census blocks and geographical boundary lines.

19. A method according to claim 16 wherein the at least one hazard parameter is specified on the basis of hazard type.

20. A method according to claim 19 wherein the hazard type comprises at least one from the group consisting of: weather, earthquakes and wild fires.

21. A method according to claim 16 wherein the at least one hazard parameter is specified on the basis of a pre-determined numeric threshold.

22. A method according to claim 16 wherein the hazard data is acquired using at least one from the group consisting of: FTP, remote Web service API, and remote Web content.

23. A method according to claim 16 wherein the hazard data is aggregated using a standardized coordinate system.

24. A method according to claim 16 wherein the entities comprise insured property.

25. A method according to claim 24 wherein the potential loss exposure comprises financial loss associated with damage to insured property.

26. A method according to claim 16 wherein the entities comprise insured populations.

27. A method according to claim 26 wherein the potential loss exposure comprises financial loss associated with the impact of the hazard on the insured population.

28. A method according to claim 27 wherein the financial loss is associated with at least one from the group consisting of loss of life, disability and job disruption.

29. A method according to claim 16 wherein the potential loss exposure is reported to the user using at least one from the group consisting of: portfolio monitoring Web services, hazard analysis reports and data streams.
